(19) United States
(12) Patent Application Publication
(10) Pub. No.: US 2026/0307750 A1
(43) Pub. Date: Oct. 8, 2026

(54) CARRIER FOR TRANSFERRING LOADS ACROSS A CORRUGATED SURFACE

(71) Applicant: Clifton Development and Designs Pty Ltd, Red Hill, Queensland (AU)

(72) Inventor: Timothy Scott Clifton, Red Hill, Queensland (AU)

(21) Appl. No.: 19/485,148

(22) PCT Filed: May 15, 2024
(86) PCT No.: PCT/AU2024/050483

§ 371 Date: Nov. 17, 2025

(30) Foreign Application Priority Data
May 17, 2023 (AU) 2023901518

(51) Int. Cl. B62D 55/26; B62D 55/14

(52) U.S. Cl. CPC B62D 55/26; B62D 55/14

(57) ABSTRACT

A carrier for transferring loads across a corrugated surface, the carrier comprising a body having a width and a length defining a support surface arranged to bear a load, the body including opposed first and second tracks; a first loop of rollers about the first track and a second loop of rollers about the second track; cross members extending from rollers of the first track to rollers of the second track; wherein a gap between adjacent cross members is greater than a crest width of the corrugated surface and wherein a width of each of the cross members is less than a pan width of the corrugated surface.

### TECHNICAL FIELD

The present invention relates to a carrier for transferring loads across a corrugated surface.

### BACKGROUND

Any references to methods, apparatus or documents of the prior art are not to be taken as constituting any evidence or admission that they formed, or form part of the common general knowledge.

Many works are conducted at heights on or through roofs which may be made from corrugated materials. Some of these works conducted at heights require repetitive movements, dexterity, and/or manual handling practices which increase the time to complete certain tasks as well as increases the risk of a user suffering a repetitive strain injury.

Tool belts and other user worn devices are known but require the user to bear the weight and may reduce dexterity and flexibility of the user. Accordingly, devices or tools which reduce the need for repetitive movements and/or assist in reducing the time to complete tasks when conducted at heights are sought.

### SUMMARY OF INVENTION

In an aspect, the invention provides a carrier for transferring loads across a corrugated surface, the carrier comprising:
a body having a width and a length defining a support surface arranged to bear a load, the body including opposed first and second tracks;
a first loop of rollers about the first track and a second loop of rollers about the second track;
cross members extending from rollers of the first track to rollers of the second track;
wherein a gap between adjacent cross members is greater than a crest width of the corrugated surface and wherein a width of each of the cross members is less than a pan width of the corrugated surface,
wherein each of the first and second loops of rollers comprise a plurality of pairs of rollers connected by a bracket member, and
wherein the bracket members are connected by one or more link members to adjacently positioned bracket members on each of the first and second loops of rollers.

In an embodiment, the first track and the second track are arranged substantially orthogonal to the support surface.

In an embodiment, the first track is coupled to a first side wall of the body extending substantially orthogonal to the support surface which bears the load and the second track is coupled to a second side wall extending substantially orthogonal to the support surface.

In an embodiment, the gap is configured by the length of the one or more link members.

In an embodiment, each of the rollers are rotatably connected within the respective first or second loop by a pin or rod.

In an embodiment, each of the one or more link members is greater than or equal to the length of the crest of the corrugated surface.

In an embodiment, the first and second tracks extend substantially the length of the body.

In an embodiment, each of the first and second tracks comprise a lip extending substantially orthogonal to the track so as to define a channel for retaining the rollers to the respective first or second track.

In an embodiment, each of the cross members extend substantially the width of the body.

In an embodiment, each of the cross members comprises one or more casters or omni directional wheels.

In an embodiment, each of the one or more casters or omni-directional wheels is arranged for contacting the pan of the corrugated surface.

In an embodiment, the carrier comprises a brake mechanism for preventing movement of the first and second loops relative to the tracks.

In an embodiment, the carrier comprises a compartment.

In an embodiment, the compartment comprises a cover.

In an embodiment, the cover comprises a lock for securing the compartment.

In an embodiment, the support surface is arcuate or at least comprises longitudinal end portions which are raised relative to the central portion of the support surface when in use.

In an embodiment, the central portion of the support surface may define a seat for a user.

In another aspect, the invention provides a method for manoeuvring a carrier as described above, the method comprising:
applying a force substantially parallel to the crests of the corrugated surface such that one of the cross members reacts against a crest of the corrugated surface so as to cause the first and second loop of rollers to rotate around respective first and second tracks thereby moving the carrier relative to the corrugated surface.

In an embodiment, the method further comprises applying a force substantially perpendicular to the crests of the corrugated surface such that the one or more casters or omni-directional wheels rotate to move the carrier relative to the corrugated surface.

In another aspect there is provided a method for transporting a load across a corrugated surface, the method comprising:
providing a carrier having a body with a length and width defining a support surface for bearing a load and at least two opposing side walls extending away from the support surface, wherein each side wall comprises opposed first and second tracks and loop of rollers coupled to the first and second tracks, having longitudinal cross members extend between the loops of rollers wherein a gap between adjacent cross members is greater than a crest width of the corrugated surface, wherein a width of each of the cross members is less than a pan width of the corrugated surface,
wherein each of the first and second loops of rollers comprise a plurality of pairs of rollers connected by a bracket member, and wherein respective adjacent bracket members of the first and second loops of rollers are connected by one or more link members;
loading a load onto the support surface of the carrier; and
applying a force to the body of the carrier substantially parallel to a width direction of the crests on the corrugated surface such that each of the loops of rollers rotate around their respective tracks.

In another aspect, there is provided a method of assembling a carrier for use in transporting loads across a corrugated surface, the method comprising:
providing a body having a support surface and at least two opposing side walls that extend away from the support surface;
coupling first and second loops of rollers connected by a plurality of longitudinally extending cross members onto respective first and second tracks;
wherein a gap between adjacent cross members is greater than a crest width of the corrugated surface and wherein a width of each of the cross members is less than a pan width of the corrugated surface,
wherein each of the first and second loops of rollers comprise a plurality of pairs of rollers connected by a bracket member, and
wherein respective adjacent bracket members of the first and second loops of rollers are connected by one or more link members.

In an embodiment, the method further comprises providing the support surface having longitudinal end portions which are raised relative to the central portion of the support surface when in use.

### BRIEF DESCRIPTION OF THE DRAWINGS

Preferred features, embodiments and variations of the invention may be discerned from the following Detailed Description which provides sufficient information for those skilled in the art to perform the invention. The Detailed Description is not to be regarded as limiting the scope of the preceding Summary of the Invention in any way. The Detailed Description will make reference to a number of drawings as follows:

FIG. 1 is an isometric view of a carrier in accordance with an embodiment of the present invention.

FIG. 2 is a side view of a carrier in accordance with an embodiment of the present invention.

FIG. 3 is a cross section of the carrier of FIG. 2.

FIG. 4 is a side view of a carrier in accordance with an embodiment of the present invention.

FIG. 5 is a cross section of the carrier according to an embodiment of the present invention.

FIG. 6 is a side view of an alternative embodiment of the carrier according to an embodiment of the present invention.

FIG. 7 is a top view of the carrier of FIG. 6 having the support surface removed.

FIG. 8 is an upper isometric view of a carrier as seen in FIG. 6 showing the support surface installed.

### DETAILED DESCRIPTION OF PREFERRED EMBODIMENTS

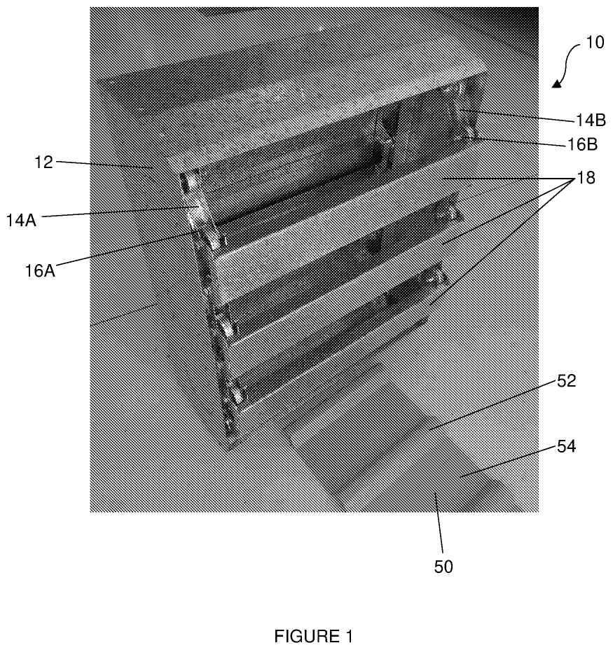

FIGS. 1 to 3 illustrate a carrier 10 for use in transferring loads across a corrugated surface 50. In the preferred embodiment, the carrier 10 comprises a body 12 adapted for bearing a load, which will be discussed in further detail below. The body 12 further comprising first and second tracks 14A, 14B (collectively referred to as the tracks 14). Preferably, the tracks 14 are opposingly arranged within the body 10. A first loop of rollers 16A is rotatably arranged around the first track 14A and a second loop of rollers 16B is rotatably arranged around the second track 14B. Each of the rollers 15 are free to rotate about a central axis of rotation. In addition, the first and second loops of rollers 16A, 16B rotate around a respective one of the first or second track 14A, 14B.

The body 12 preferably comprises at least two opposing side walls 12A, 12B which extend away from the support surface 30. The at least two opposing side walls 12A, 12B provide respective points for mounting the first and second tracks 14A, 14B. This configuration ensures that the at least two opposing side walls 12A, 12B are substantially orthogonal to the support surface 30 and/or the corrugated surface 50. Further, this configuration ensures that the tracks 16 and the loops of rollers 16A, 16B are substantially orthogonal to the support surface and/or the corrugated surface 50.

A plurality of cross members 18 are connected to and extend between the first loop of rollers 16A at a respective first end of a respective cross member 18 to the second loop of rollers 16B at a second end of the respective cross member 18. The connection of the cross members 18 to the first and second loops of rollers 16A, 16B causes the cross members 18 to rotate around the tracks 14 in unison. The cross members 18 are spaced apart along the first and second loops of rollers 16A, 16B defining a gap therebetween adjacent cross members 18. Preferably, the gap between cross members 18 is uniform throughout the first and second loops of rollers 16A, 16B. In the preferred embodiment, each of the gaps between adjacent cross members 18 is greater than or equal to a width of a crest 52 of a corrugated surface 50. In the preferred embodiment, a width of each of the cross members 18 is less than or equal to a width of the pan 54 of a corrugated surface 50.

Throughout the present specification there may be reference to crest 52 and pan 50 of the corrugated surfaces 50. Corrugated surfaces 50 are provided having a number of different profiles. In some instances, the corrugated surface 50 means a surface having a ribbed profile. The present invention may be adapted for a given profile but is particularly beneficial for corrugated surfaces 50 having cyclical and/or ribbed profiles as seen in FIGS. 1, 2 and 4. Accordingly, crest 52 refers to the cyclical projection from a baseline of the corrugated surface 50 whereas pan 54 refers to the baseline of the corrugated surface 50. In some instances, the pan 54 may be referred to as a trough. The person skilled in the art would readily appreciate these terms and their meanings as it relates to corrugated surfaces 50.

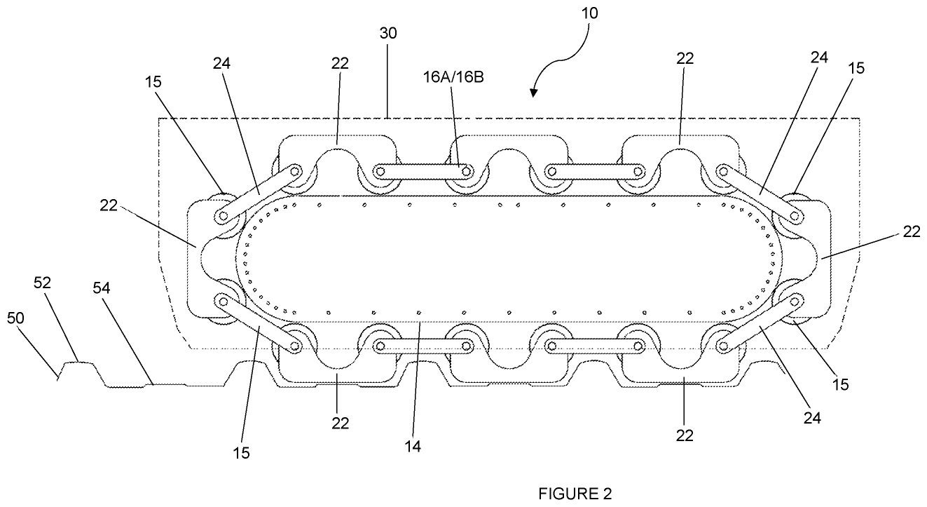

Referring to FIG. 2, there is provided a side view of the carrier 10 with the body 10 hidden and shown in dashed line. The carrier 10 is engaged with the corrugated surface 50. In the preferred embodiment, each of the loops of rollers 16 comprise a plurality of pairs of rollers 15, each pair of rollers 15 being coupled together by a bracket member 22. Bracket members 22 are connected by way of one or more link members 24 to form each of the first and second loops of rollers 16A, 16B, respectively. In alternative embodiments, the plurality of rollers 15 may be directly connected to each other by the one or more link members 24 without the bracket members 22. In further alternative embodiments, each of the first and second loops 16A, 16B may be formed by a combination of bracket members 22 connected directly to adjacent rollers 15.

As mentioned above, the gap between adjacent cross members 18 is greater than or equal to the width of the crest 52 of the corrugated surface 50. The gap between adjacent cross members 18 may be altered and configured for different profiles which the corrugated surface 50 may be provided. To alter the width of the gap, the one or more link members 24 may be replaced with longer link members 24. In the preferred embodiment, the gap between adjacent cross members 18 is preferably uniform. However, the gaps between adjacent cross members 18 may be variable and configured to be based on the profile of the specific corrugated surface 50.

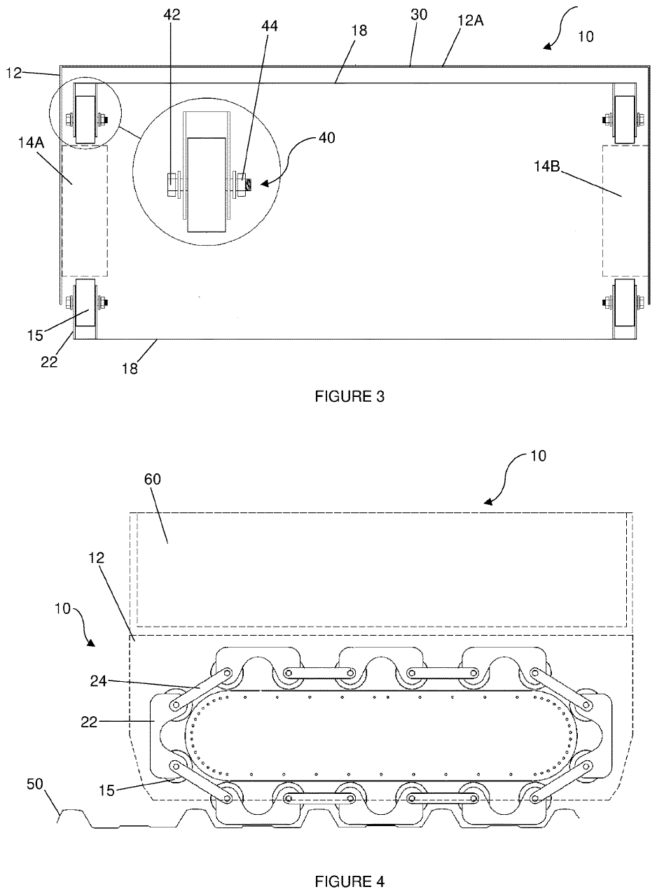

As best seen in the close-up section of the roller in FIG. 3, each of the rollers 15 may be rotatably connected to the bracket member 22 and/or the one or more link members 24 by way of a pin or rod. In the preferred embodiment, the pin or rod is in the form of a bolt and nut arrangement 40. The bolt and nut arrangement 40 comprises a bolt 42 having threaded end portion and a nut 44 having the bracket member 22, roller 15 and one or more link members 24 therebetween. The as a middle portion of the bolt 42 which the rollers 15 rotate about is smooth, the rollers 15 are free to rotate while also allowing the one or more link members 24 and the respective bracket members 22 flex and articulate with respect to one another. The person skilled in the art would readily appreciate that there are a number of connection means which would be available for use to allow the rollers 15 to rotate and the one or more link members 24 to flex and articulate relative to the bracket member 22.

The body 12 of the carrier 10 is arranged to bear a load. In the preferred embodiment, the body 12 comprises a flat top surface 12A (as seen in FIG. 3) which may hold and bear the weight of a load. In other embodiments, the top surface 12A may be slightly sloped towards a point central point. In alternative embodiments, the body 12 may be configured having a compartment 60 for holding a load as seen in FIG. 4. The compartment 60 may be open to the air and provide means for holding parts, materials and other components for use while on the corrugated surface 50. In further embodiments which comprise a compartment 60, the compartment may comprise a cover or a lid (not shown). Said cover or lid may further comprise a lock for securing a load within the compartment 60. The person skilled in the art would readily appreciate there are a large number of compartment/cover/lock combinations known in the art that may be utilised for the present invention.

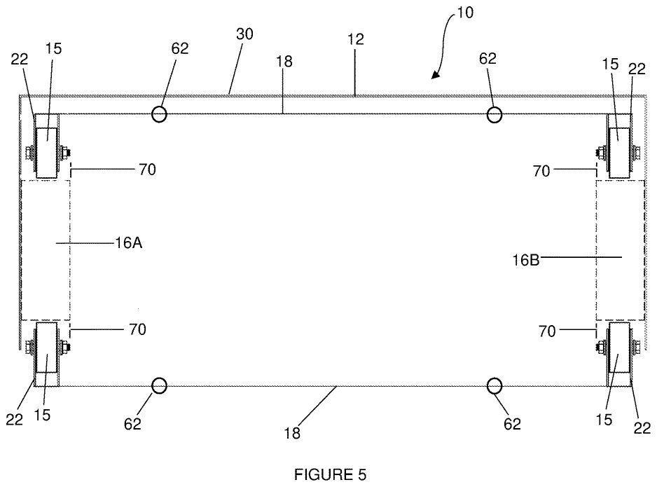

As best seen in FIG. 5, in an alternative embodiment, each of the first and second tracks 14A, 14B may comprise a lip 70 extending substantially orthogonal to the respective track 14. The lip 70, the track 14 and a wall of the body 12 may define a channel for assisting in guiding and retaining the rollers 15 to the respective first or second track 14A, 14B. The lip 70 may not be preferable in some embodiments. In others, it may be determined based on the length of the cross members 18 and the width of the tracks 14 and rollers 15.

As the carrier 10 is intended to bear a load, stability of the carrier 10 is important. Accordingly, in the preferred embodiment, the first and second tracks 14A, 14B extend substantially the length of the body 12. In the preferred embodiment, the cross members 18 extend substantially the width of the body 12. These features assist in ensure that when the carrier 10 is bearing a load, only minimal to no load will be applied at a point past where the cross members 18 engaged with the corrugated surface 50 which would encourage the carrier 10 to tip over. The weight of the carrier 10 itself may further assist in preventing the carrier 10 from tipping over.

Referring again to FIG. 5, in some alternative embodiments, the cross members 18 of the carrier 10 may comprise one or more casters 62 or omni-directional wheels. In an embodiment, each of the cross members comprises one or more casters 62 or omni directional wheels. The carrier 10 is able to move transverse to the crests 52 of the corrugated surface 50 by rotation of the cross members 18 about the tracks 14. The casters 62 allow the carrier 10 to move parallel to the crests 52 of the corrugated surface 50. The casters 62 contact the pan 54 of the corrugated surface 50 and rotate as a force is applied to the carrier 10 in a direction substantially parallel with the crests 52 of the corrugated surface 50. Preferably, the casters 62 hold the cross members 18 slightly above the pan 54 of the corrugated surface 50 so as to reduce friction between the corrugated surface and the cross members 18.

In alternative embodiments, the carrier 10 may comprise a brake member (not shown). The brake member may intersect with the loops of rollers 16A, 16B an embodiment, the carrier comprises a brake mechanism for preventing movement of the first and second loops relative to the tracks 14. In some embodiments, the cross members 18 may comprise a layer of material to increase the friction between the corrugated surface 50 and the cross member 18. Such a layer of a material with or without the brake mechanism may assist where the corrugated surface 50 is gently sloping. The present invention is particularly advantageous for flat corrugated surfaces. However, the present invention may also be useful on sloped corrugated surfaces.

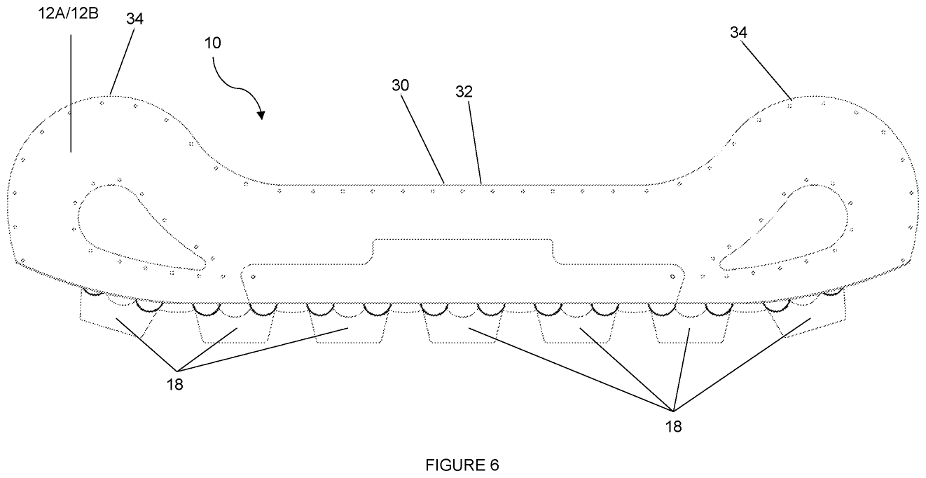

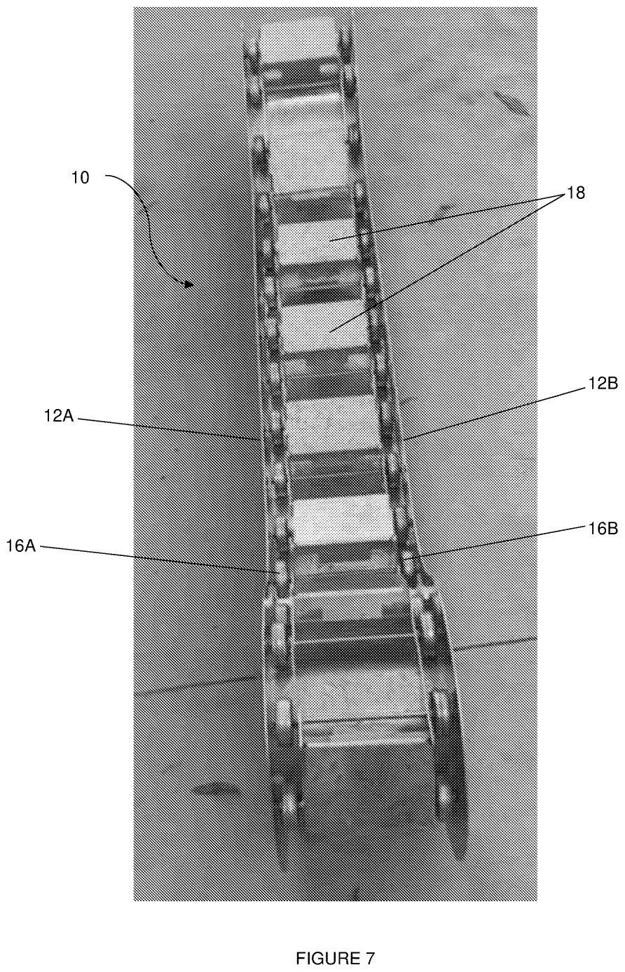

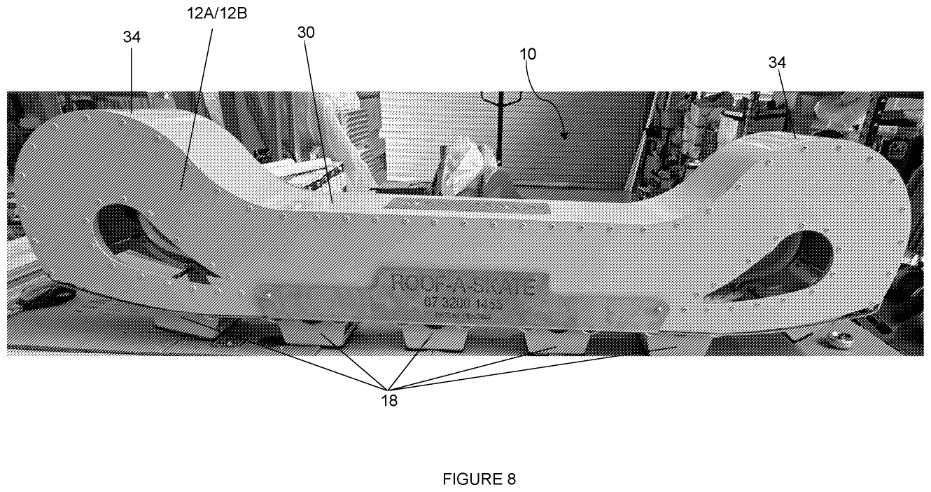

FIGS. 6 to 8, illustrates an alternative embodiment of the carrier 10. While the carrier 10 shown in FIGS. 6, 7 and 8 operates by the same principles as the carrier 10 shown in FIGS. 1 to 5, the support surface 30 is provided having longitudinal end portions 34 which are relatively higher than the generally central portion 34. This provides a section of the support surface 30 which may be used for holding one or more items or tools.

In some embodiments, the support surface 30 may be substantially arcuate. The support surface 30 may also comprise a coating or material to roughen the surface to assist in preventing materials from slipping off the support surface 30. In some embodiments, the support surface 30 may be used as a seat for a user. This may reduce repetitive motions required bending and standing while conducting repetitive work across the corrugated surface 50.

In the embodiments shown in FIGS. 6 to 8, the tracks 14A, 14B may be attached to the at least two opposing side walls 12A, 12B only at the longitudinal ends 34. This allows the loops of rollers 16A, 16B to have some movement and adjust accordingly. As such, the tension is held in the loops of rollers 16A, 16B only at a section engaging with the corrugated surface 50 allowing the section of the loops of rollers 16A, 16B hidden within the body 10 to rest under the effect of gravity thereby applying tension to the section engaging with the corrugated surface 50. Alternatively, the whole loops of rollers 16A, 16B may be held in tension with one or more rollers (not shown) on an underside portion of the support surface 30 to prevent the loops of rollers 16A, 16B from damaging the support surface 30.

The method for manoeuvring the carrier 10 as described above will be described with regard to the Figures generally.

The carrier 10 of the present invention is intended to be freely able to be moved by way of applying a force substantially parallel to the corrugated surface 50. Applying a force substantially transverse to the crests 52 of the corrugated surface 50 will cause the cross members 18 to engage with the crests 52 thereby causing the first and second loops of rollers 16A, 16B to rotate about the tracks 14. This will allow the carrier 10 to move across the crests 52 of a corrugated surface 50 in a direction substantially transverse to the crests 52 of the corrugated surface 50. Applying a force substantially parallel to the crests 52 of the corrugated surface 50 will cause the casters 62 to rotate allowing the carrier 10 to move in a direction parallel to the crests 52 along the corrugated surface 50. In some embodiments, the carrier 12 may be able to move both transverse and parallel to the crests 52 of the corrugated surface 50 simultaneously.

The method of transporting a load across the corrugated surface 50 includes providing the carrier 10 according to one of the embodiments as described in detail above. Loading the load onto support surface 30. Subsequently, the user applies a force or at least part of a force to the carrier 10 in a direction substantially parallel to the corrugated surface 50. As the loops of rollers 16A, 16B are free to rotate around the tracks 14A, 14B, the crests 52 along the corrugated surface 50 prevent the cross members 18 from merely sliding across the corrugated surface 50. Instead, the crests 52 of the corrugated surface 50 engagement with the cross members 18 cause the loops of rollers 16A, 16B to rotate around their respective tracks 14A, 14B. This allows the body of the carrier 10 to move across the corrugated surface 50.

The method of assembly may be done in several different orders of manners. The tracks 14A, 14B may be secured to the respective one of the opposing side walls 12A, 12B prior to affixing to the support surface 30 defining the body 12. The lip 70 may be affixed to the respective one of the tracks 14A, 14B after the respective one of the loop of rollers 16A, 16B is mounted onto the track to prevent it from coming off of the track 14A, 14B. The cross members 18 may be installed prior to the lip 70 so as to prevent the loops of rollers 16A, 16B from coming off of their respective tracks 14A, 14B. The loops of rollers 16A, 16B may be assembled in a linear fashion and looped or routed around the respective track 14A, 14B and secured to itself once it has been mounted onto the respective track 14A, 14B Finally, the support surface 30 may be installed last to facilitate better access to the components within the body 12 of the carrier 10.

The present invention is particularly advantageous where a worker is conducting repetitive work, particularly at heights. The carrier 10 reduces or avoids the need to make repetitive movements thereby reducing repetitive strain injuries from poor manual handling. The carrier 10 may also be beneficial when used as a seat for a user working across a corrugated surface 50.

In compliance with the statute, the invention has been described in language more or less specific to structural or methodical features. The term “comprises” and its variations, such as “comprising” and “comprised of” is used throughout in an inclusive sense and not to the exclusion of any additional features.

In compliance with the statute, the invention has been described in language more or less specific to structural or methodical features. The term “includes” and its variations, such as “including” and “inclusive of” is used throughout in an inclusive sense and not to the exclusion of any additional features.

It is to be understood that the invention is not limited to specific features shown or described since the means herein described comprises preferred forms of putting the invention into effect.

The invention is, therefore, claimed in any of its forms or modifications within the proper scope of the appended claims appropriately interpreted by those skilled in the art.

Labelling of repeated features throughout the Figures has been limited to avoid confusion.

1. -22. (canceled)

23. A carrier for transferring loads across a corrugated surface, the carrier comprising:
a body having a width and a length defining a support surface arranged to bear a load, the body including opposed first and second tracks;
a first loop of rollers about the first track and a second loop of rollers about the second track;
cross members extending from rollers of the first track to rollers of the second track;
wherein a gap between adjacent cross members is greater than a crest width of the corrugated surface and wherein a width of each of the cross members is less than a pan width of the corrugated surface,
wherein each of the first and second loops of rollers comprise a plurality of pairs of rollers connected by a bracket member, and
wherein the bracket members are connected by one or more link members to adjacently positioned bracket members on each of the first and second loops of rollers.

24. The carrier according to claim 23, wherein the first track and the second track are arranged substantially orthogonal to the support surface.

25. The carrier according to claim 23, wherein the first track is coupled to a first side wall of the body extending substantially orthogonal to the support surface which bears the load and the second track is coupled to a second side wall extending substantially orthogonal to the support surface.

26. The carrier according to claim 23, wherein the gap is configured by the length of the one or more link members.

27. The carrier according to claim 23, wherein each of the one or more link members is greater than or equal to the length of the crest of the corrugated surface.

28. The carrier according to claim 23, wherein each of the rollers are rotatably connected within the respective first or second loop by a pin or rod.

29. The carrier according to claim 23, wherein the first and second tracks extend substantially the length of the body.

30. The carrier according to claim 23, wherein each of the first and second tracks comprise a lip extending substantially orthogonal to the track so as to define a channel for retaining the rollers to the respective first or second track.

31. The carrier according to claim 23, wherein each of the cross members extend substantially the width of the body.

32. The carrier according to claim 23, wherein each of the cross members comprises one or more casters or omni directional wheels.

33. The carrier according to claim 32, wherein each of the one or more casters or omni-directional wheels is arranged for contacting the pan of the corrugated surface.

34. The carrier according to claim 23, wherein the carrier comprises a brake mechanism for preventing movement of the first and second loops relative to the tracks.

35. The carrier according to claim 23, wherein the carrier comprises a compartment.

36. The carrier according to claim 35, wherein the compartment comprises a cover.

37. The carrier according to claim 36, wherein the cover comprises a lock for securing the compartment.

38. The carrier according to claim 23, wherein the support surface is arcuate or at least comprises longitudinal end portions which are raised relative to the central portion of the support

39. The carrier according to claim 38, wherein the central portion of the support surface may define a seat for a user.

40. A method for transporting a load across a corrugated surface, the method comprising:
providing a carrier having a body with a length and width defining a support surface for bearing a load and at least two opposing side walls extending away from the support surface, wherein each side wall comprises opposed first and second tracks and loop of rollers coupled to the first and second tracks, having longitudinal cross members extend between the loops of rollers wherein a gap between adjacent cross members is greater than a crest width of the corrugated surface, wherein a width of each of the cross members is less than a pan width of the corrugated surface, wherein each of the first and second loops of rollers comprise a plurality of pairs of rollers connected by a bracket member, and wherein respective adjacent bracket members of the first and second loops of rollers are connected by one or more link members;
loading a load onto the support surface of the carrier; and
applying a force to the body of the carrier substantially parallel to a width direction of the crests on the corrugated surface such that each of the loops of rollers rotate around their respective tracks.

41. A method of assembling a carrier for use in transporting loads across a corrugated surface, the method comprising:
providing a body having a support surface and at least two opposing side walls that extend away from the support surface;
coupling first and second loops of rollers connected by a plurality of longitudinally extending cross members onto respective first and second tracks;
wherein a gap between adjacent cross members is greater than a crest width of the corrugated surface and wherein a width of each of the cross members is less than a pan width of the corrugated surface,
wherein each of the first and second loops of rollers comprise a plurality of pairs of rollers connected by a bracket member, and
wherein respective adjacent bracket members of the first and second loops of rollers are connected by one or more link members.

42. The method according to claim 40, wherein the method further comprises providing the support surface having longitudinal end portions which are raised relative to the central portion of the support surface when in use.
